(19) United States
(12) Patent Application Publication
(10) Pub. No.: US 2014/0011029 A1
(43) Pub. Date: Jan. 9, 2014

(54) Semiconductive Shield Composition with Improved Strippability

(71) Applicant: Paul J. Brigandi, Schwenksville, PA (US)

(72) Inventor: Paul J. Brigandi, Schwenksville, PA (US)

(21) Appl. No.: 14/001,603

(22) PCT Filed: Mar. 27, 2012
(86) PCT No.: PCT/US12/30658

§ 371 Date: Aug. 26, 2013

Related U.S. Application Data
(60) Provisional application No. 61/468,869, filed on Mar. 29, 2011.
(60) Provisional application No. 61/469,227, filed on Mar. 30, 2011.

(51) Int. Cl. H01B 7/38

(52) U.S. Cl. CPC H01B 7/38
USPC 428/390; 252/511

(57) ABSTRACT

Cable insulation shields comprising, in weight percent based upon the weight of the insulation shield, (A) 37-53% of ethylene vinyl acetate (EVA) having 30-33 wt % of units derived from vinyl acetate, (B) 10% or more nitrile butadiene rubber (NBR) having 25 to 55 wt % of units derived from acrylonitrile, and (C) 35% or more carbon black having (1) 80-115 milliliters per 100 grams (ml/100 g) dibutyl phthalate (DBP) absorption value, (2) 30 to 60 milligrams per gram (mg/g) iodine absorption (I2NO, and (3) 0.3 to 0.6 grams per milliliter (g/ml) apparent density), exhibit a strip force against an adjacent crosslinked polyethylene insulating layer of less than 5.4 kN/m (15 pounds per one-half inch).

### BACKGROUND OF THE INVENTION

1. Field of the Invention

This invention relates to strippable wire and cable coatings. In one aspect, the invention relates to a strippable semiconductive shield for use in electrical conductors such as power cables that exhibits improved strippability, i.e., a lower force required for removing the shield from the insulating layer.

2. Description of the Related Art

A typical power cable generally comprises one or more conductors in a cable core that is covered by layers of polymeric materials including a first semiconducting shield layer (conductor or strand shield), an insulating layer, usually cross-linked polyethylene (XLPE), a second semiconducting shield layer (insulation shield), a metallic tape or wire shield, and a protective jacket. The outer semiconducting shield can be either bonded to the insulation or strippable, with most applications using strippable shields.

One current technology for strippable power cable sheaths is described in U.S. Pat. No. 4,286,023, U.S. Pat. No. 6,858,296 and EP 0 420 271 A1. These compositions comprise an ethylene vinyl acetate copolymer (EVA) with a vinyl acetate comonomer content of 33 weight percent (wt %), an acrylonitrile-butadiene copolymer (NBR), carbon black, antioxidant, and organic peroxide. This current technology has a typical strip force of approximately 15-20 pounds per half inch (lb/0.5″) on average. There is a continuing need to reduce the strip force required to remove the insulation shield to improve the ease of cable installations.

### SUMMARY OF THE INVENTION

In one embodiment the invention is a composition comprising, in weight percent based upon the weight of the composition, (A) 37-53% of ethylene vinyl acetate (EVA) having 30-33 wt % of units derived from vinyl acetate, (B) 10% or more, preferably 10 to 15%, nitrile butadiene rubber (NBR) having 25 to 55 wt % of units derived from acrylonitrile, (C) 35% or more, preferably 35 to 45%, carbon black having (1) 80-115 milliliters per 100 grams (ml/100 g) dibutyl phthalate (DBP) absorption value, (2) 30 to 60 milligrams per gram (mg/g) iodine absorption (I₂NO, and (3) 0.3 to 0.6 grams per milliliter (g/ml) apparent density), and (D) 0.6-1% organic peroxide. This composition can be processed into a cable insulation sheath with surprisingly low strip force as compared to a cable insulation sheath prepared from a composition comprising the same components but in different amounts.

In one embodiment the invention is a cable comprising an insulation shield that comprises, in weight percent based upon the weight of the insulation shield, (A) 37-53% of EVA having 30-33 wt % of units derived from vinyl acetate, (B) 10% or more, preferably 10 to 15%, NBR having 25 to 55 wt % of units derived from acrylonitrile, and (C) 35% or more, preferably 35 to 45%, carbon black having (1) 80-115 ml/100 g DBP absorption value, (2) 30 to 60 mg/g iodine absorption (I₂NO), and (3) 0.3 to 0.6 g/ml apparent density. The insulation shield layer is adjacent to and in contact with an insulation layer, and the insulation shield layer peels from the insulation layer with surprisingly low strip compared to an insulation shield layer comprising the same components but in different amounts.

### DETAILED DESCRIPTION OF THE PREFERRED EMBODIMENT

Definitions

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

Numerical ranges include all values from and including the lower and the upper values, in increments of one unit, provided that there is a separation of at least two units between any lower value and any higher value. As an example, if a compositional, physical or other property, such as, for example, molecular weight, etc., is from 100 to 1,000, then all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the amounts of the various components of the inventive composition, various properties of the components of the inventive composition, and the like..

“Wire” and like terms mean a single strand of conductive metal, e.g., copper or aluminum, or a single strand of optical fiber.

“Cable” and like terms mean at least one wire or optical fiber within a sheath, e.g., an insulation covering or a protective outer jacket. Typically, a cable is two or more wires or optical fibers bound together, typically in a common insulation covering and/or protective jacket. The individual wires or fibers inside the sheath may be bare, covered or insulated. Combination cables may contain both electrical wires and optical fibers. The cable, etc. can be designed for low, medium and high voltage applications. Typical cable designs are illustrated in U.S. Pat. Nos. 5,246,783, 6,496,629 and 6,714,707.

“Composition” and like terms mean a mixture or blend of two or more components.

Ethylene Vinyl Acetate (EVA)

Ethylene vinyl acetate is a well known polymer and is readily available commercially, e.g., ELVAX® EVA resins available from DuPont. The vinyl acetate content of the EVA resins used in the practice of this invention typically have a minimum vinyl acetate content is at least 28, more typically at least 29 and even more typically at least 30, wt %. The maximum vinyl acetate content of the EVA resins used in the practice of this invention typically is not greater than 35, more typically not greater than 34 and even more typically not greater than 33, w %.

The amount of EVA in the inventive semiconductive shielding composition is typically between 40 and 50 wt %, more typically between 42 and 48 wt %.

Nitrile Butadiene Rubber (NBR)

Nitrile butadiene rubber (NBR) is a family of unsaturated copolymers of 2-propenenitrile and various butadiene monomers (1,2-butadiene and 1,3-butadiene). Although its physical and chemical properties vary depending on the polymer's composition of nitrile, this form of synthetic rubber is generally resistant to oil, fuel, and other chemicals (the more nitrile within the polymer, the higher the resistance to oils but the lower the flexibility of the material).

The nitrile content of the NBR resins used in the practice of this invention typically have a minimum nitrile content is at least 25, more typically at least 30 and even more typically at least 35, wt %. The maximum nitrile content of the NBR resins used in the practice of this invention typically is not greater than 55, more typically not greater than 45 and even more typically not greater than 40, w %.

The amount of NBR in the inventive semiconductive shielding composition is typically between 10 and 20 wt %, more typically between 10 and 15 wt %.

Conductive Carbon Black

The conductivity of carbon blacks is generally correlated to their morphological structure which can be characterized by different experimental parameters, particularly by porosity, measured by means of dibutyl phthalate (DBP) oil absorption. Usually carbon blacks that have high DBP absorption values have high conductivity and are said to be “highly structured.”

The carbon black used in the invention typically has a DBP absorption value, as measured by ASTM D2414-09a (Standard Test Method for Carbon Black—Oil Absorption Number (OAN)), of 80 to 115 milliliters per 100 grams (ml/100 g), typically 85 to 110 ml/100 g, and more typically 90 to 105 ml/100 g. The carbon black has an apparent density range, as measured by ASTM D1513-05e1 (Standard Test Method for Carbon Black—Pour Density), of 0.3 and 0.6 grams per milliliter (g/ml), typically of 0.35 and 0.55 g/ml, and more typically of 0.4 and 0.5 g/ml. The carbon black has an iodine absorption range, as measured by ASTM D1510-09b (Standard Test Method for Carbon Black—Iodine Absorption Number), of 30 and 60 milligrams per gram (mg/g), typically of 35 to 55 mg/g, and more typically of 40 to 50 mg/g.

Representative examples of carbon blacks include ASTM grade N550 and N660. These carbon blacks have iodine absorptions ranging from 9 to 14 gram per kilogram (g/kg) and average pore volumes ranging from 10 to 150 cubic centimeters per 100 grams (cm³/100 g). Generally, smaller particle sized carbon blacks are employed, to the extent cost considerations permit. The carbon black is included in the semiconductive shield composition in an amount of 35 wt % or more, typically in the range of 35 to 45 wt %, preferably 37 to 43 wt %. A preferred carbon black for use in wire and cable semiconductive shielding compositions is CSX-614 carbon black from Cabot Corporation.

Organic Peroxide

The composition of this invention includes an organic peroxide crosslinking agent, preferably in an amount of from 0.2 to 2 percent by weight, based on the weight of the composition. Useful organic peroxide crosslinking agents include, but are not limited to, di(tert-buylperoxyisopropyl)benzene, dicumyl peroxide, di(tert-butyl) peroxide, and 2,5-dimethyl-2,5-di(tert-butylperoxy)-hexane. Various other known coagents and crosslinking agents may also be used. For example, organic peroxide crosslinking agents are disclosed in U.S. Pat. No. 3,296,189.

The semiconductive insulating compositions used in the practice of this invention may contain additional additives including but not limited to antioxidants, curing agents, cross linking co-agents, boosters and retardants, processing aids, coupling agents, ultraviolet absorbers or stabilizers, antistatic agents, nucleating agents, slip agents, plasticizers, lubricants, viscosity control agents, tackifiers, anti-blocking agents, surfactants, extender oils, acid scavengers, and metal deactivators. Additives can be used in amounts ranging from less than about 0.01 to more than about 10 wt % based on the weight of the composition.

The insulation sheath can also comprise one or more fillers and/or flame retardants. Examples of fillers and flame retardants include but are not limited to clays, precipitated silica and silicates, fumed silica calcium carbonate, ground minerals, aluminum trihydroxide, magnesium hydroxide and carbon blacks with arithmetic mean particle sizes larger than 15 nanometers. Fillers and flame retardants can be used in amounts ranging from minimally filled , e.g., 10, 5, 1, 0.1, 0.01 percent or even less, to highly filled, e.g., 40, 50, 60, 65 percent or even more, based on the weight of the composition.

Compounding of a cable insulation material can be effected by standard equipment known to those skilled in the art. Examples of compounding equipment are internal batch mixers, such as a BANBURY™ or BOLLING™ internal mixer. Alternatively, continuous single, or twin screw, mixers can be used, such as FARREL™ continuous mixer, a WERNER and PFLEIDERER™ twin screw mixer, or a BUSS™ kneading continuous extruder. The type of mixer utilized, and the operating conditions of the mixer, will affect properties of a semiconducting material such as viscosity, volume resistivity, and extruded surface smoothness.

A cable containing a metal conductor and a polymeric insulation layer can be prepared with various types of extruders, e.g., single or twin screw types. A description of a conventional extruder can be found in U.S. Pat. No. 4,857,600. An example of co-extrusion and an extruder therefore can be found in U.S. Pat. No. 5,575,965. A typical extruder has a hopper at its upstream end and a die at its downstream end. The hopper feeds into a barrel, which contains a screw. At the downstream end, between the end of the screw and the die, there is a screen pack and a breaker plate. The screw portion of the extruder is considered to be divided up into three sections, the feed section, the compression section, and the metering section, and two zones, the back heat zone and the front heat zone, the sections and zones running from upstream to downstream. In the alternative, there can be multiple heating zones (more than two) along the axis running from upstream to downstream. If it has more than one barrel, the barrels are connected in series. The length to diameter ratio of each barrel is in the range of about 15:1 to about 30:1. In wire coating where the polymeric insulation is crosslinked after extrusion, the cable often passes immediately into a heated vulcanization zone downstream of the extrusion die. The heated cure zone can be maintained at a temperature in the range of about 150 to about 350° C., preferably in the range of about 170 to about 250° C. The heated zone can be heated by pressurized steam, or inductively heated pressurized nitrogen gas. The invention is described more fully through the following examples. Unless otherwise noted, all parts and percentages are by weight.

SPECIFIC EMBODIMENTS

Sample Preparation

The vulcanizable semiconductive compositions in this disclosure are prepared in a BUSS™ co-kneader for cable extrusion. The formulations used in these examples are reported in Table 1. All components are expressed in weight percent based on the total weight of the composition.

TABLE 1
Example Compositions

| | | Trade | | | |
|---|---|---|---|---|---|
| Raw Material | Supplier | Name | Comparative | Historical | Experimental |
| Ethylene Vinyl Acetate | Exxon | ESCORENE | 51.8 | 44.6 | — |
| (EVA) Copolymer (33% | | 782 | | | |
| VA, 30MI) | | | | | |
| Ethylene Vinyl Acetate | Exxon | ESCORENE | — | — | 45.4 |
| (EVA) Copolymer (33% | | 783 | | | |
| VA, 43MI) | | | | | |
| Carbon Black | Cabot | CSX-614 | 35.7 | 34.0 | 40.2 |
| | Corp. | | | | |
| Nitrile Rubber | Zeon | NIPOL | 9.9 | 19.0 | 11.9 |
| | Chemicals | DP5161 | | | |
| Additive Package | | | 2.5 | 2.4 | 2.5 |

Test Method for Cable Strip Tension

From the cable two parallel cuts are made down toward the insulation with a 0.5 inch separation with a scoring tool designed to remove the insulation shield in strips parallel to the cable axis. The strip tension force, reported in pounds per one-half inch (lb/0.5″), is measured with an INSTRON™ according to ICEA T-27-581/NEMA WC-53 (Adhesion).

### EXAMPLE 1

The 25 kV cables are extruded with triple layers onto a #1/0-19W stranded aluminum conductor wire. The target dimensions for the cable are 0.015 inch/0.260 inch/0.040 inch for the conductor shield/insulation/insulation shield. The strip force results are reported in Table 2.

TABLE 2
Example 1 Strip Force Results

| | Avg. Strip |
|---|---|
| Compound | (lb/0.5″) |
| Comparative | 16 |
| Experimental | 8 |

### EXAMPLE 2

The 25 kV cables are extruded with triple layers onto the 750 kcmil stranded aluminum conductor wire. The target dimensions for the cable are 0.015 inch/0.220 inch/0.040 inch for the conductor shield/insulation/insulation shield. The strip force results are reported in Table 3.

TABLE 3
Example 2 Strip Force Results

| | Avg Strip |
|---|---|
| Compound | (lb/0.5″) |
| Comparative | 17.5 |
| Experimental | 11.5 |

### COUNTER EXAMPLE

The performance of comparative and historical products is compared and reported in Table 4. The strip force of each product is similar indicating that an increase in rubber and slight decrease in carbon black did not result in reduced strip force. The 15 kV cables are extruded with triple layers onto the 1/0 19w stranded aluminum conductor wire. The target dimensions for the cable are 0.015 inch/0.175 inch/0.040 inch for the conductor shield/insulation/insulation shield.

TABLE 4
Example 2 Strip Force Results

| | Avg Strip |
|---|---|
| Compound | (lb/0.5″) |
| Historical | 12.8 |
| Comparative | 11.7 |

Although the invention has been described with certain detail through the preceding description of the preferred embodiments, this detail is for the primary purpose of illustration. Many variations and modifications can be made by one skilled in the art without departing from the spirit and scope of the invention as described in the following claims.

1. A composition comprising, in weight percent based upon the weight of the composition, (A) 37-53% of ethylene vinyl acetate (EVA) having 30-33 wt % of units derived from vinyl acetate, (B) 10% or more nitrile butadiene rubber (NBR) having 25 to 55 wt % of units derived from acrylonitrile, (C) 35% or more carbon black having (1) 80-115 milliliters per 100 grams (mL/100 g) dibutyl phthalate (DBP) absorption value, (2) 30 to 60 milligrams per gram (mg/g) iodine absorption (I₂NO, and (3) 0.3 to 0.6 grams per milliliter (g/ml) apparent density), and (D) 0.6-1% organic peroxide.

2. The composition of claim 1 in which the EVA is present in an amount of 40 to 50 wt %.

3. The composition of claim 1 in which the NBR is present in an amount of 10 and 20 wt %.

4. The composition of claim 1 in which the carbon black is present in an amount of 35 to 45 wt %.

5. The composition of claim 4 in which the carbon black has a DBP absorption value of 85 to 110 ml/100 g.

6. The composition of claim 5 in which the carbon black has an apparent density of 0.35 to 0.55 g/ml.

7. The composition of claim 6 in which the carbon black has an iodine absorption of 35 to 55 mg/g.

8. The composition of claim 1 in which the organic peroxide is at least one of di(tert-buylperoxyisopropyl)benzene, dicumyl peroxide, di(tert-butyl) peroxide, and 2,5-dimethyl-2,5-di(tert-butylperoxy)-hexane.

9. A cable comprising an insulation shield that comprises, in weight percent based upon the weight of the insulation shield, (A) 37-53% of ethylene vinyl acetate (EVA) having 30-33 wt % of units derived from vinyl acetate, (B) 10% or more nitrile butadiene rubber (NBR) having 25 to 55 wt % of units derived from acrylonitrile, and (C) 35% or more carbon black having (1) 80-115 milliliters per 100 grams (ml/100 g) dibutyl phthalate (DBP) absorption value, (2) 30 to 60 milligrams per gram (mg/g) iodine absorption (I₂NO, and (3) 0.3 to 0.6 grams per milliliter (g/ml) apparent density).

10. The cable of claim 9 in which the insulation shield comprises 40 to 50 wt % EVA.

11. The cable of claim 9 in which the insulation shield comprises 10 and 20 wt % NBR.

12. The cable of claim 9 in which the insulation shield comprises 35 to 45 wt % carbon black.

13. The cable of claim 9 in which the carbon black has a DBP absorption value of 85 to 110 ml/100 g.

14. The cable of claim 13 in which the carbon black has an apparent density of 0.35 to 0.55 g/ml.

15. The cable of claim 14 in which the carbon black has an iodine absorption of 35 to 55 mg/g.
